(19) United States
(12) Patent Application Publication
(10) Pub. No.: US 2022/0097171 A1
(43) Pub. Date: Mar. 31, 2022

(54) METHOD FOR PROCESSING AT LEAST ONE WORKPIECE

(71) Applicant: TRUMPF Laser- und Systemtechnik GmbH, Ditzingen (DE)

(72) Inventors: Felix Zimmermann, Ditzingen (DE); Sebastian Hecker, Salem (DE)

(21) Appl. No.: 17/546,095

(22) Filed: Dec. 9, 2021

Related U.S. Application Data
(63) Continuation of application No. PCT/EP2020/067164, filed on Jun. 19, 2020.

(30) Foreign Application Priority Data
Jun. 21, 2019 (DE) 10 2019 116 798.1

(51) Int. Cl. B23K 26/0622; B23K 26/06; B23K 26/073; B23K 26/26

(52) U.S. Cl. CPC B23K 26/0624; B23K 26/26; B23K 26/073; B23K 26/0648

(57) ABSTRACT

A method is for processing at least one workpiece. The method includes applying a pulsed laser beam to a process zone of the at least one workpiece. The energy coupled into the process zone by the laser beam is temporally modulated.

### CROSS REFERENCE TO RELATED APPLICATIONS

This application is a continuation of International Application No. PCT/EP2020/067164 (WO 2020/254616 A1), filed on Jun. 19, 2020, and claims benefit to German Patent Application No. DE 10 2019 116 798.1, filed on Jun. 21, 2019. The aforementioned applications are hereby incorporated by reference herein.

### FIELD

The present invention relates to a method for processing at least one workpiece by means of short laser pulses, for example for welding two workpieces to one another.

### BACKGROUND

For processing workpieces, and in particular for welding two workpieces to one another, the respective workpieces may be impinged, in a process zone by means of a laser beam, in order to produce a melt in the process zone impinged on by the laser beam by way of energy absorption, the melt forming a weld seam between the two workpieces after solidification.

In this case, for producing a weld of a transparent workpiece to a non-transparent workpiece or for welding two transparent workpieces, the process zone may be placed between the two workpieces. This may be achieved by the processing laser beam being focused into the process zone in such a way that the energy input is the highest in the region of the process zone, in order, correspondingly, to provide a melt between the two workpieces in the process zone, and then to provide a weld seam after the solidification of the melt. In this case, the processing laser beam correspondingly passes through one of the transparent workpieces and is focused into the process zone only on the opposite side of the workpiece with respect to the entrance region.

In this case, the processing laser beam is focused by corresponding optical units and beam shaping associated therewith into the material of one of the workpieces, into both workpieces and/or into the region of an interface between the two workpieces bearing against one another, in order then to form the respective process zone in this region.

During the processing of workpieces, and in particular during the welding of two workpieces to one another, in the process zone high temperatures that are not present in the surrounding material regions occur on account of the high local energy input as a result of the focused laser beam. Accordingly, the heat necessary for the processing—for example for the production of a weld seam—in the process zone results in thermal stresses vis-à-vis the surrounding material regions. Accordingly, stresses and/or cracks can occur in the material in the region of the weld seam, which can result in a reduction of the quality of the joined materials.

This equally also applies to other local processing methods in which local volume or surface modifications are carried out. In these further processing methods, too, the shape and size of the local volume or surface modifications are limited by the permissible thermal stresses in the surrounding material regions.

The thermal stresses that occur, in particular during the actual heat input, accordingly have a limiting effect on the size and shape of the modification to be introduced in the process zone. In other words, the known welding methods are limited by the fact that the thermal stresses introduced by way of the local heat input should not exceed a specific measure that might result in a structural alteration of the material, in cracks or in a low quality of the weld seam or of the workpieces joined to one another.

### SUMMARY

In an embodiment, the present disclosure provides a method that is for processing at least one workpiece. The method includes applying a pulsed laser beam to a process zone of the at least one workpiece. The energy coupled into the process zone by the laser beam is temporally modulated.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic illustration of a pulsed laser beam whose energy is temporally modulated, wherein the energy of the individual laser pulses is temporally modulated relative to the following laser pulses in the form of a sawtooth;

FIG. 2 shows a further schematic illustration of a pulsed laser beam whose energy is temporally modulated, wherein the energy of the individual laser pulses is temporally modulated relative to the following laser pulses in sinusoidal fashion (or sin²ⁿ where n=natural number);

FIG. 3 shows a further schematic illustration of a pulsed laser beam whose energy is temporally modulated, wherein the energy of the individual laser pulses is temporally modulated relative to the following laser pulses in rectangular fashion;

FIG. 4 shows a schematic illustration of a pulsed laser beam whose energy is modulated with a high frequency (in the kHz range), wherein the individual laser pulses whose energy is modulated are subject to a superposed modulation of the average energy of the individual pulse trains, and also a microscope micrograph of a workpiece processed with such a laser beam;

FIG. 5 shows a schematic illustration of a laser beam whose average energy is modulated with a slow modulation of the pulse trains, but without the energy modulation carried out with a high frequency in the kHz range as present in FIG. 4, and also a microscope micrograph of a workpiece processed with such a laser beam;

FIG. 6 shows a schematic illustration of a plan view of the spots of a pulsed laser beam that are introduced into a workpiece, and also underneath that a schematic illustration of the temporally modulated energy of the respective laser pulses, wherein the energy of the entire pulse train is temporally modulated in sinusoidal fashion;

FIG. 7 shows a schematic illustration of the modulation of the temporal spacing between the laser pulses of a pulsed laser beam;

FIG. 8 shows a schematic illustration of the modulation of the temporal spacing between laser pulses of a pulsed laser with simultaneous temporal modulation of the energy of the pulsed laser beam, wherein the energy of the entire pulse train is temporally modulated in the form of a sawtooth;

FIG. 9 shows a schematic illustration of the temporal modulation of the pulse durations of the laser pulses with simultaneous temporal modulation of the energy of the individual laser pulses;

FIG. 10 shows a schematic illustration of the temporal modulation of the pulse durations of the laser pulses with simultaneous temporal modulation of the energy of the individual laser pulses in a further variant;

FIG. 11 shows a schematic illustration of the spots that are introduced into a workpiece by the individual laser pulses, and underneath that schematically the illustration of a modulation of the temporal spacing between the laser pulses of the pulsed laser beam;

FIG. 12 shows a schematic illustration of the spots that are introduced into a workpiece by way of the laser pulses, and underneath that schematically the illustration of a modulation of the temporal spacing between the laser pulses of the pulsed laser beam, and also underneath that a schematic illustration of the relative feed speed between workpiece and focus of the laser beam;

FIG. 13 shows a schematic illustration of a pulsed laser beam whose energy is temporally modulated, wherein the energy of the laser pulses is modulated in sinusoidal fashion and a pulse pause is included in the modulation; and

FIG. 14 shows a schematic illustration of a set-up of a device for welding two workpieces by means of a pulsed laser beam.

### DETAILED DESCRIPTION

The present disclosure relates to a method for processing at least one workpiece by means of short laser pulses, for example for welding two workpieces to one another, in particular for welding a transparent workpiece to a further workpiece or for welding two transparent workpieces to one another.

Proceeding from the state of the art, the present invention provides an improved method for processing workpieces that uses pulsed laser beams.

An aspect of the present disclosure provides a method for processing at least one workpiece, preferably for welding two workpieces, comprising applying a pulsed laser beam, preferably an ultrashort pulse laser beam, to a process zone of the at least one workpiece. The energy coupled into the process zone by the laser beam is temporally modulated.

As a result of the temporal modulation of the energy coupled into the process zone by the laser beam, the thermal stresses produced in the material can be reduced by comparison with processing that is carried out without this modulation. In the case of the stresses, it is possible to reduce both so-called transient stresses, which occur during and after the actual processing when the material is still heated, and permanent stresses.

As a result of the temporal modulation of the energy coupled into the process zone by the laser beam, it is possible to modulate the local heat accumulation in such a way that a more homogeneous coupling of the energy into the process zone is achieved. What can thus be achieved, inter alia, is that the average energy that can be used to effect welding without the occurrence of undesired cracks in the material can be increased, such that this can result in an improved efficiency of the processing. It is thus also possible to shift the limitations regarding the size and shape of the modification which is introduced into the material and which enables crack-free processing to be effected.

What can be achieved by the modulation of the energy coupled into the process zone is that the thermal diffusion processes that take place in the material of the workpiece can be better utilized to achieve simultaneously both a more efficient energy input and thus a shortening of the processing time, and as well a reduction of stresses in the material in this case.

Depending on the modulation frequency chosen, a more homogeneous coupling of energy into the process zone can be achieved in this case, in comparison with modulation-free processing.

With the use of pulsed laser beams, and in particular with the use of ultrashort laser pulses, the modification introduced into the material can be produced either by way of an overlap of the respective laser pulses in the material, or else by way of a spatially separated impingement of the laser pulses in the material.

When impinging on the material with a high overlap of the laser pulses, a modulation of the degree of heat accumulation in the material can accordingly be achieved as a result of a temporal modulation of the energy coupled into the process zone. The modulations to be used also depend in particular on the typical thermal diffusion time of the material. If the time until the next laser pulse at the same location or at the overlapping location does not suffice to allow sufficient diffusion of heat input by way of the laser pulse within the material, then a highly local heat accumulation occurs when the next laser pulse appears in the overlap region. What can accordingly be achieved by way of a temporal modulation of the energy coupled in is that the typical thermal diffusion time of the material is employed in such a way as to reduce the occurrence of transient stresses and permanent stresses in the material, since the diffusion of the heat into other regions can advantageously be used for reducing the stresses. The heat is advantageously distributed in the workpiece in order, in this way, to reduce the disadvantageous occurrence of high temperature gradients in the material of the workpiece, and thus, simultaneously to reduce the occurrence of thermal stresses.

With the use of an overlapping introduction of the laser pulses into the material, an improvement in the processing result can accordingly be achieved by way of the temporal modulation of the energy coupled in.

By contrast, if the respective laser pulses are introduced into the workpiece as spatially separated spots, then for example a defined crack guidance can be achieved by way of a corresponding temporal modulation of the energy coupled in, which crack guidance may be desirable for example for separating a workpiece, for example for separating glass.

Preferably, the energy coupled into the process zone by the laser beam is temporally modulated by a modulation of the temporal spacing between the laser pulses and/or between the pulse trains, preferably with constant energy per laser pulse and/or pulse train, wherein the repetition rate is preferably modulated between 10 kHz and 1 GHz.

Preferably, energy coupled into the process zone by the laser beam is temporally modulated by a modulation of the pulse duration of the laser pulses, wherein the pulse duration is preferably modulated between 0.1 ps and 20 ps.

Preferably, the energy coupled into the process zone by the laser beam is temporally modulated by a modulation of the average energy and/or of the energy distribution of successive pulses and/or of the pulse trains, preferably with constant temporal spacing between the successive laser pulses and/or pulse trains.

Preferably, the energy coupled into the process zone by the laser beam is temporally modulated by a pulse pause, preferably by a pulse pause of 0.05 ms to 5 ms.

Preferably, the pulse energy and/or the pulse duration and/or the length of a pulse train are/is temporally modulated by a control unit of a laser beam source that generates the pulsed laser beam, wherein the modulation is preferably controlled by way of an external signal transmitter.

Preferably, the energy coupled into the process zone by the pulsed laser beam is modulated by means of a shutter and/or an acousto-optical modulator and/or is deflected by means of an acousto-optical deflector (AOD), and the energy introduced into the process zone is thus modulated. The deflection and modulation by means of an AOD preferably relates to modulation frequencies of greater than 1 MHz.

Preferably, the energy coupled into the process zone by the pulsed laser beam is generated by means of a temporal modulation of aberrations, preferably by means of a deformable mirror and/or by means of a TAG lens (“tunable acoustic gradient”) lens. In the case of a TAG lens, a liquid is provided which has a temporally modulated refractive index distribution as a result of acousto-optical modulation, such that the focal length of the lens is thereby temporally modulated.

Preferably, a laser beam having a Bessel beam shape is used for processing the at least one workpiece.

Preferably, a pulsed laser beam having in a process zone at least two beam profiles offset longitudinally with respect to one another and/or laterally with respect to one another, preferably at least two Gaussian profiles offset longitudinally with respect to one another and/or laterally with respect to one another, is used for processing the at least one workpiece.

According to an aspect of the present disclosure, a device is provided for processing at least one workpiece, comprising a laser source for generating a pulsed laser beam and an optical unit for applying the pulsed laser beam to a process zone in the at least one workpiece. According to the present disclosure, the laser source is configured to temporally modulate the pulsed laser beam.

The advantages already mentioned above with respect to the method are achieved in this way.

Preferably, the laser source is temporally modulated by means of an external signal transmitter.

Preferably, an Axicon and/or a diffractive optical element and/or a spatial light modulator are/is arranged between the laser source and the process zone.

Preferred exemplary embodiments are described below with reference to the figures. In this case, identical, similar or identically acting elements are provided with identical reference signs in the various figures, and a repeated description of these elements is dispensed with in some instances, in order to avoid redundancies.

For processing a workpiece, for example for welding two workpieces, in particular for welding two transparent workpieces, or for introducing other volume or surface modifications in the workpiece or on the surface thereof, it is possible to use a pulsed laser beam, preferably an ultrashort pulsed laser beam, which accordingly impinges on a process zone of the workpiece or of both the workpieces. For this purpose, the pulsed laser beam is typically focused into the process zone by means of an optical unit in order, accordingly, to achieve a particularly high energy density in the region of the process zone, and at the same time, the lowest possible energy input into the surrounding material regions.

The energy of the laser pulses of the pulsed laser beam is partly absorbed by the material present in the process zone, and accordingly, results in a rise in the temperature in the process zone. With each laser pulse, new energy is accordingly supplied to the process zone and results in a renewed increase in the temperature of the material in the process zone. At the same time, the heat is dissipated from the process zone to surrounding volume regions of the material by thermal diffusion processes, such that, taking into account the typical thermal diffusion coefficient of the material of the workpiece in the case of laser pulses impinging successively on the process zone, either a temperature increase, a constant temperature in the process zone, or a temperature decrease in the case of a high temperature already present can occur. This depends, in each case, on whether the temperature can be increased by the laser pulses more rapidly than it diffuses out of the process zone as a result of the thermal diffusion processes in the material.

The fact of whether heat accumulation or a thermal diffusion takes place in the process zone is accordingly substantially determined by the frequency of the successive laser pulses and the energy of the laser pulses that is introduced into the material. In the case of processing that involves a relative speed between the workpiece and the processing laser beam, a spatial overlap (N>1) of the laser spots is also be present, wherein focus size (D), repetition rate (R) and feed (V) define the pulse overlap (N=D*R/V).

In order to reduce the formation of transient or permanent stresses within the workpiece, an aspect of the present disclosure provides for temporally modulating the energy coupled into the process zone by the laser beam.

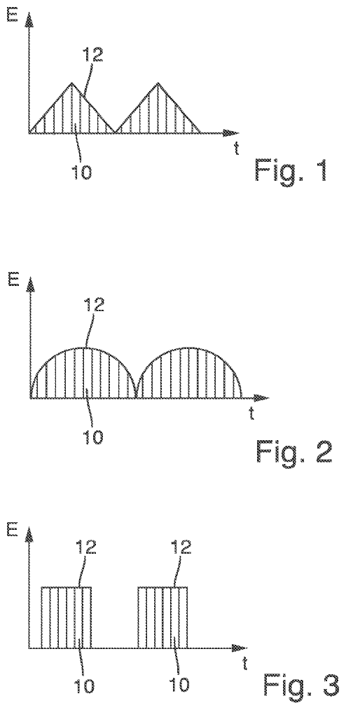

FIG. 1 schematically shows a variant of the temporal modulation of the energy of the individual laser pulses or pulse groups of the pulsed laser beam that are applied to the process zone. In this case, the laser energy (E) is plotted against time (t). The individual laser pulses 10 or pulse groups are indicated schematically by the lines and are bounded by an envelope 12.

The laser pulses 10 represented as lines can in principle also illustrate pulse groups of laser pulses. In this case, the temporal modulation of the energy of the successive laser pulses or of the laser pulse groups is of importance. In other words, an inter-pulse modulation of the energy of the laser pulses or laser pulse groups is involved.

FIG. 1 accordingly shows a temporal modulation of the energy of the individual laser pulses 10 relative to the following laser pulses in the form of a sawtooth function, represented by the envelope 12.

The temporal modulation of the energy of the individual laser pulses 10 relative to the following laser pulses can be achieved either by means of the laser source itself, or by means of an optical element that is interposed between the laser source and the process zone and brings about a temporal modulation of the energy of the pulsed laser beam. This applies to all embodiments and modulation patterns disclosed here.

FIG. 2 illustrates a schematic illustration of a temporal modulation of the laser energy E of the individual laser pulses 10 over time, in the case of which the envelope 12 of the energies of successive laser pulses or of laser pulse groups exhibits a quasi-sinusoidal modulation.

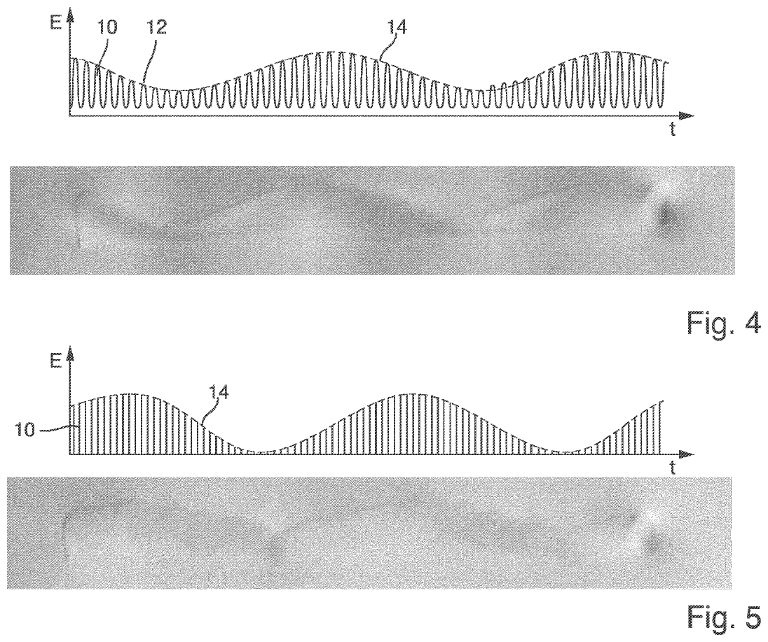

FIG. 3 schematically shows a temporal modulation of the laser pulses 10, in the case of which the envelope 12 of the energies of successive laser pulses exhibits a quasi-rectangular modulation. FIG. 4 shows, in the upper part of the figure, a temporal modulation of the laser energy E of the laser pulses 10 with a fast, sinusoidal envelope 12, which can be provided for example with a modulation frequency of between 10 Hz and 10 GHz. A likewise sinusoidal modulation 14 is superposed on the envelope 12. In this embodiment, the frequency of the superposed modulation 14 is constant and can be for example in a range of 0.01 Hz to 2.5 kHz.

The frequency of the slow modulation can be tuned to the length of a processed line. By way of example, 10 mm line length can be welded at 10 mm/s and a slow 1 Hz modulation 14 can be used in this case.

In an alternative embodiment, however, the modulation 14 can also have a varying frequency.

The corresponding manifestation of the superposed modulation 14 as shown in FIG. 4 results in the variation of the average energy and/or the energy distribution of successive laser pulses 10 or of successive laser pulse groups, which is shown by the envelope 12.

Underneath the diagram of the laser energy over time, the figure shows a microscope micrograph of a cross section (in the micrograph, the laser beam was radiated in from above and the process zone that arose was moved from left to right) of the material modification written into a workpiece by means of the modulation 14 superposed on the envelope 12. It is evident that the material modification follows the temporally modulated energy of the laser pulses.

FIG. 5 then shows for comparison a diagram of laser pulses 10 whose energy is varied only by way of a slow modulation 14, but not by way of the fast modulation as in FIG. 4. Underneath that, the material modification written into a workpiece by way of a slow modulation 14 is evident in a microscope micrograph of a cross section, which reveals that the material modification does not follow the temporally modulated energy of the laser pulses particularly accurately. The material modification that arises is formed very inhomogeneously in comparison.

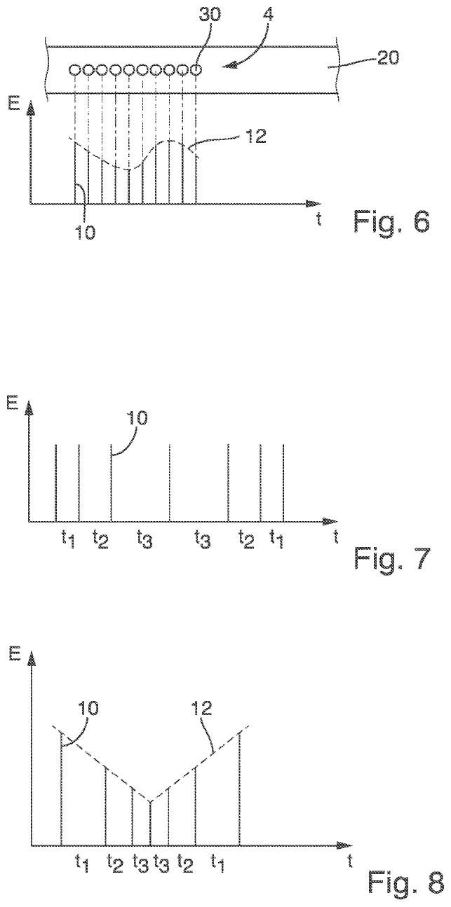

FIG. 6 schematically shows in the upper illustration a workpiece 20 with laser spots 30 depicted therein, the laser spots overlapping to a small extent. Underneath that, the figure shows schematically an illustration of the individual laser pulses 10, the energy of which is temporally modulated such that in respectively adjacent laser spots 30 in the material 20 in each case a different energy can be coupled into the workpiece and thus also into the process zone 4 in the workpiece.

FIG. 7 schematically shows a modulation of the temporal spacing between the individual laser pulses 10. In this case, by way of example, a time t1 is provided between the first and second laser pulses, a longer time t2 is provided between the second and third laser pulses, and an even longer time t3 is provided between the third and fourth laser pulses, wherein then again the same time t3 until the following laser pulse, then again time t2 and then time t1 are used, etc. A modulation of the temporal spacing between the respective laser pulses 10 accordingly takes place here.

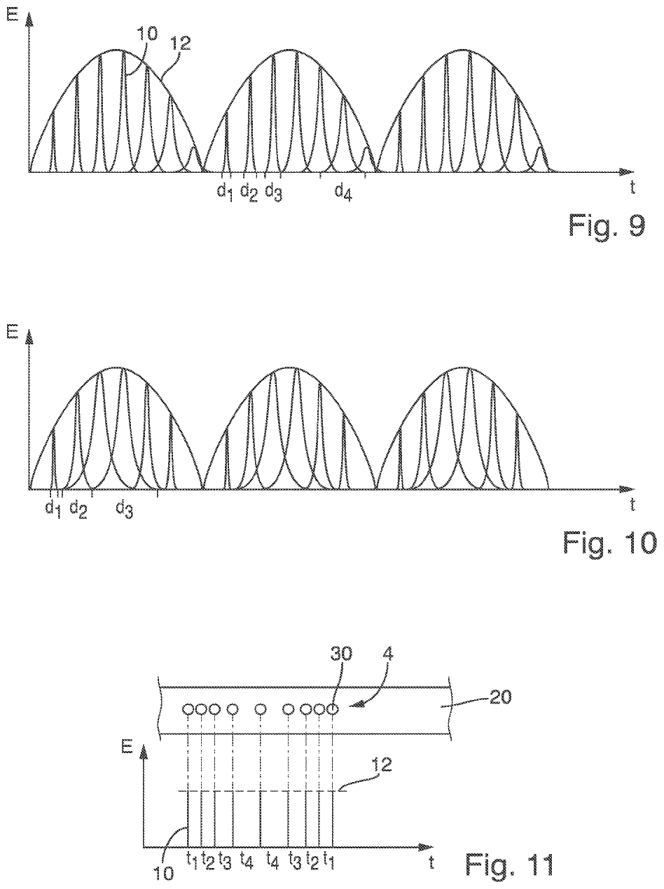

FIG. 8 shows a further schematic illustration of the modulation of the temporal spacing between the individual laser pulses 10, at the same time a temporal modulation of the laser energy E also being performed, which follows the envelope 12. In this case, the laser energy E of the laser pulses 10 decreases towards the shorter temporal spacings between the laser pulses 10 and increases again towards the longer temporal spacings.

FIG. 9 shows an embodiment in which the pulse duration d1, d2, d3, d4 of the laser pulses 10 is temporally modulated—for example between 0.1 and 20 ps. The pulse duration of the laser pulses within a pulse train rises here.

At the same time it is also possible to modulate the repetition frequency between 10 kHz and 1 GHz. The energy of the respective laser pulses can also be temporally modulated in such a way as to result in the envelope 12, exhibiting the quasi-sinusoidal function.

FIG. 10 shows an embodiment similar to FIG. 9, in which case, however, the pulse duration d1, d2, d3 here firstly rises towards the centre of the envelope 12 and then falls again. There is no departure from the scope of the present invention if the pulse duration is modulated differently from FIG. 9 and FIG. 10.

FIG. 11 shows a further schematic illustration of a workpiece 20, in the case of which laser spots 30 are once again shown in a process zone 4, but are at different distances from one another here, wherein there are laser spots 30 which overlap one another and wherein there are laser spots 30 which are separated from one another.

The schematic illustration of the individual laser pulses 10 over time that is shown underneath that reveals that the temporal spacing between each two laser pulses is modulated here, provision being made of four different temporal spacings between the respective laser pulses 10. In this way, the energy coupled into the process zone 4 by means of the laser beam at the respective laser spots 30 can be temporally modulated, wherein this simultaneously also results in a spatial modification of the energy coupled into the process zone 4.

In this exemplary embodiment, both the feed speed V between the laser beam and the workpiece and the energy coupled into the workpiece 20 or into the process zone 4 of the workpiece 20 by each laser pulse 10 are of identical magnitude.

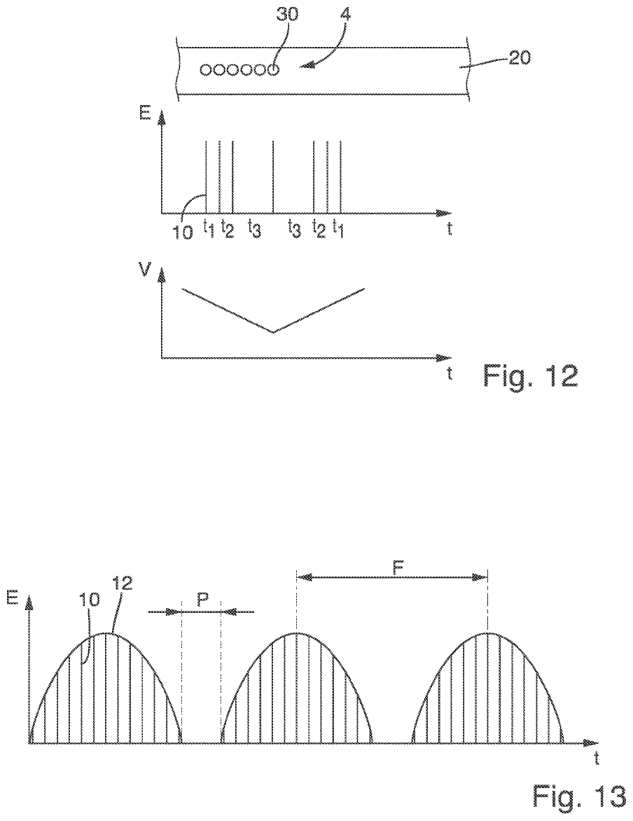

FIG. 12 shows a further illustration of a schematically indicated workpiece 20, in the case of which individual laser spots 30 are introduced into a process zone 4. The laser spots 30 are at identical distances from one another in the workpiece 20. The diagram underneath that shows the individual laser pulses 10 once again in their temporal sequence, wherein the spacing between two successive laser pulses 10 is temporally modulated in each case. Three different temporal spacings between the laser pulses t1, t2, t3 are shown schematically here.

Underneath that the figure shows a variable relative feed speed V between the laser beam and the workpiece 20, wherein the feed speed is lower in the regions in which a longer temporal spacing is provided between two successive laser pulses 10. It is accordingly evident from this that, despite the different temporal spacing between the individual laser pulses 10, the laser spots 30 are nevertheless arranged at identical distances from one another in the workpiece 20.

The energy coupled into the process zone 4 by way of the laser beam is temporally modulated to the effect that in the regions in which the spacing between the successive laser pulses is larger, the workpiece 20 accordingly has a longer period of time to dissipate the heat from the process zone 4 into the surrounding material. Accordingly, a temporal modulation of the energy coupled into the process zone takes place with utilization of the thermal diffusion time of the material 20.

FIG. 13 shows a further schematic illustration of a pulsed laser beam to be coupled into the process zone, in the case of which the individual laser pulses 10 are temporally modulated with regard to their laser energy E, wherein the modulation forms an envelope 12 describing a quasi-sinusoidal function, wherein the sinusoidal function has a fixed modulation frequency F. A pulse pause P is provided in each case between the individual pulse groups.

The pulse pause P here can have a length of between 0.05 ms and 5 ms. The pulse pause P is concomitantly included here in the temporal modulation of the energy of the laser pulses.

If ultrashort laser pulses are focused into the volume or onto the surface of transparent materials, e.g. quartz glass, the high intensity present at the focus results in non-linear absorption processes, whereby, depending on the laser parameters, different material modifications can be induced. By moving the focus position (scanning the laser focus or the sample), it is thus possible to modify extended regions, wherein focus size (D), repetition rate (R) and feed (V) define the pulse overlap (N=D*R/V). Process regimes both with spatially separated (N<1) and with overlapping (N>1) pulses or pulse trains (so-called bursts) are addressed herein. With high overlap, heat accumulation can occur if the temporal pulse spacing is shorter than the typical thermal diffusion time of the glass. As a result, the temperature in the focus region increases from pulse to pulse, as a result of which the local melting of the glass can occur. If the modification is positioned in the interface of two glasses, the cooling melt generates a stable connection of both samples.

Both in the case of processing with feed and in the case of stationary processing, the temporal modulation (e.g. sawtooth, sinusoidal or rectangular, of the coupled-in pulse energy can reduce the (transient and permanent) stresses induced in the material. With heat accumulation and high pulse overlap, the average power (and thus the size of the modification introduced) at which crack-free welding can be effected increases as a result. Depending on the modulation frequency, it is possible here to generate a (more) homogeneous coupling-in of energy (typically at modulation frequencies of 100 Hz to approximately 5 kHz) in comparison with modulation-free processing or else to impress a dynamic characteristic on the modification process (typically, at modulation frequencies of >5 kHz).

Likewise, in a process regime of spatially separated spots, an energy modulation of successive pulses (or pulse trains) can foster a defined crack guidance, which is desired e.g. for glass separation.

In this case, the modulation can have various temporally periodic profiles, in particular modulation amplitudes, modulation rises or else positive and negative damping. In this case, the modulation is independent of the beam shape used, wherein in particular non-Gaussian beam shapes (e.g. Bessel) or else beam shapes composed of a plurality of (longitudinally and/or laterally) offset Gaussian profiles can be used or subject to the modulation. The modulation parameters (e.g. shape, frequency, amplitude, etc.) can additionally be varied in the process.

Moreover, further approaches are conceivable for modulating the coupled-in energy. They include changing the laser repetition rate rapidly over time, whereby e.g. the degree of heat accumulation (in the regime of high overlap) can be varied. The pulse duration could likewise be periodically varied rapidly, e.g. proceeding from 1 ps to 50 ps and back. As a result (with otherwise the same parameters) the pulse intensity possibly also falls below the modification threshold, as a result of which a modulation of the coupled-in energy likewise arises.

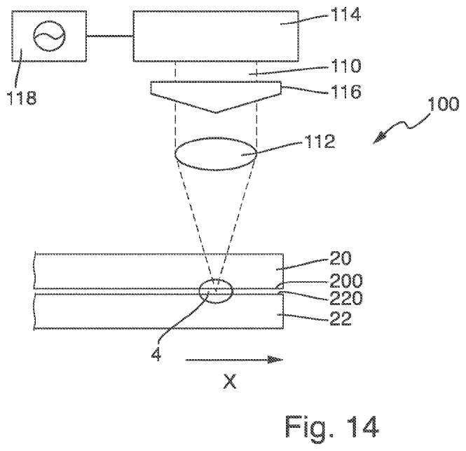

FIG. 14 is a schematic illustration of a device 100 for processing a workpiece, wherein a first workpiece 20 and a second workpiece 22 are provided here, wherein the first workpiece 20 has an underside 200 and the second workpiece 22 has a top side 220, which bear directly against one another. The underside 200 of the upper workpiece 20 and the top side 220 of the lower workpiece 22 form a plane in which a process zone 4 is intended to be formed.

A pulsed laser beam 110 is provided in a laser source 114, and is focused into the process zone 4 via an optical unit 112. The two workpieces 20, 22 are moved in a feed direction X relative to the laser beam 110.

The laser beam 110 is already modulated in the laser source 114 with regard to the temporal spacing between the laser pulses and/or between the pulse trains. At the laser source 114 the laser beam 110 can also be temporally modulated with regard to the respective pulse energy of each laser pulse 10. For this purpose, preferably an internal or else external signal transmitter 118 can be provided, by means of which the modulation of the pulse energy is controlled.

The modulation of the energy coupled into the process zone 4 by the pulsed laser beam 110 can also be achieved by means of a shutter and/or an acousto-optical modulator and/or an acousto-optical deflector, which is then likewise preferably controlled by an internal or external signal transmitter.

In one development, the energy coupled into the process zone 4 by the pulsed laser beam 110 can be modulated by means of a temporal modulation of aberrations, preferably by means of a deformable mirror and/or by means of a TAG lens.

In order to generate a Bessel beam, an Axicon 116 and/or a diffractive optical element (DOE) and/or a spatial light modulator (SLM—spatial light modulator) can be provided in the beam path. The methods for processing at least one workpiece as described herein can all preferably be carried out with a Gaussian beam or a Bessel beam.

A pulsed laser beam 110 having in the process zone 4 at least two beam profiles offset longitudinally with respect to one another and/or laterally with respect to one another, preferably at least two Gaussian profiles offset longitudinally with respect to one another and/or laterally with respect to one another, can also be used for processing the at least one workpiece 20, 22.

The self-healing properties of the Bessel beams are advantageous here, according to which, in the case of a partial disturbance or blocking at a point of the axis of propagation, for example caused by a scattering centre, the beams recover their original shape, however, later in the direction of propagation. Bessel beams are thus particularly suitable for the material processing of transparent workpieces, in the case of which material processing is intended to take place in a process zone, this being intended to take place only after the laser beam has passed through the transparent material, on an opposite side of the transparent workpiece with respect to the entrance side. As a result of the self-healing properties of the Bessel beams, possible disturbances present in the material of the workpiece have no or only a slight influence on the processing result.

Accordingly, the device comprises for example an ultrashort pulse laser, optionally additional beam shaping elements (SLM/DOE) and/or scanners (in particular micro-scanners), a focusing optical unit (e.g. microscope objective) and a sample and/or beam positioning arrangement (e.g. positioning system for sample movement). The temporal modulation of the coupled-in energy can be realized by various techniques:

By way of example, the pulse energy can be temporally modulated directly by the laser control unit.

The temporal modulation of the pulse energy can also be predefined by way of an external signal transmitter (e.g. function generator) of the laser control unit or be realized by an external device (e.g. shutter, electro/acousto-optical modulator).

The temporal modulation can be generated indirectly by temporally periodic aberrations, e.g. by means of a deformable mirror or TAG lens.

Furthermore, the modulation of the repetition rate can be realized by means of acousto-optical modulators, for example.

Alternatively, the laser pulse duration can also be modulated internally/externally.

In so far as applicable, all individual features presented in the exemplary embodiments can be combined with one another and/or interchanged, without departing from the scope of the invention.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

10 laser pulse
12 envelope
14 superposed modulation
100 device for processing at least one workpiece
110 laser beam
112 optical unit
114 laser source
116 Axicon
118 external signal transmitter
20 workpiece
22 second workpiece
200 underside of workpiece
220 top side of second workpiece
30 laser spot
4 process zone
E energy
t time
t1 temporal spacing
t2 temporal spacing
t3 temporal spacing
t4 temporal spacing
d1 pulse duration
d2 pulse duration
d3 pulse duration
d4 pulse duration
V feed speed
P pulse pause
F modulation frequency
X feed direction

1. A method for processing at least one workpiece, the method comprising:
applying a pulsed laser beam to a process zone of the at least one workpiece,
wherein the energy coupled into the process zone by the laser beam is temporally modulated.

2. The method according to claim 1, wherein the energy coupled into the process zone by the laser beam is temporally modulated by a modulation of the temporal spacing between the laser pulses or between the pulse trains.

3. The method according to claim 1, wherein the energy coupled into the process zone by the laser beam is temporally modulated by a modulation of the pulse duration of the laser pulses.

4. The method according to claim 1, wherein the energy coupled into the process zone by the laser beam is temporally modulated by a modulation of the energy distribution, of the energy of successive pulses, or of the pulse trains.

5. The method according to claim 1, wherein the energy coupled into the process zone by the laser beam is temporally modulated by a pulse pause.

6. The method according to claim 1, wherein the pulse energy, the pulse duration, or the length of a pulse train is temporally modulated by a control unit of a laser beam source that generates the pulsed laser beam.

7. The method according to claim 1, wherein the energy coupled into the process zone by the pulsed laser beam is modulated by a shutter, an acousto-optical modulator, or an acousto-optical deflector.

8. The method according to claim 1, wherein the energy coupled into the process zone by the pulsed laser beam is generated by a temporal modulation of aberrations.

9. The method according to claim 1, wherein the pulsed laser beam has a Bessel beam shape.

10. The method according to claim 1, wherein the pulsed laser beam has, in the process zone, at least two beam profiles offset longitudinally with respect to one another or laterally with respect to one another.

11. A device for processing at least one workpiece, the device comprising:
a laser source configured to generate a pulsed laser beam; and
an optical unit configured to apply the pulsed laser beam to a process zone in the at least one workpiece,
wherein the laser source is configured to temporally modulate the pulsed laser beam.

12. The device according to claim 11, wherein the laser source is temporally modulated by an internal signal transmitter or an external signal transmitter.

13. The device according to claim 11, wherein an Axicon, a diffractive optical element, an acousto-optical modulator, or an acousto-optical deflector is arranged between the laser source and the process zone.

14. The method according to claim 1,
wherein the processing comprises welding two workpieces, comprising the at least one workpiece, and
wherein applying the pulsed laser beam comprises applying an ultrashort pulse laser beam.

15. The method according to claim 2, wherein the energy coupled into the process zone by the laser beam is temporally modulated by the modulation of the temporal spacing between the laser pulses or between the pulse trains with constant energy per laser pulse or pulse train, wherein the repetition rate is modulated between 10 kHz and 1 GHz.

16. The method according to claim 3, wherein the pulse duration is modulated between 0.1 ps and 20 ps.

17. The method according to claim 4, wherein the energy coupled into the process zone by the laser beam is temporally modulated at 0.01 Hz to 2.5 kHz of the energy distribution, of the energy of successive pulses, or of the pulse trains, with constant temporal spacing between the successive laser pulses or pulse trains.

18. The method according to claim 8, wherein the energy coupled into the process zone by the pulsed laser beam is generated by the temporal modulation of aberrations by a deformable mirror or by a tunable acoustic gradient (TAG) lens.

19. The method according to claim 10, wherein the at least two profiles comprise at least two Gaussian profiles offset longitudinally with respect to one another or laterally with respect to one another.
